(19) United States
(12) Patent Application Publication
(10) Pub. No.: US 2014/0208632 A1
(43) Pub. Date: Jul. 31, 2014

(54) MEANS TO RETAIN FISHING PASTE

(71) Applicant: Richard Rhoda, Seattle, WA (US)

(72) Inventor: Richard Rhoda, Seattle, WA (US)

(21) Appl. No.: 13/750,840

(22) Filed: Jan. 25, 2013

(51) Int. Cl. A01K 83/06

(52) U.S. Cl. CPC A01K 83/06
USPC 43/44.8

(57) ABSTRACT

A soft, resilient, colorful bead to be mounted over the eye of a fishhook, the bead, in addition to having a bore to receive the eye, has a broken exterior surface to capture and retain paste-like bait.

### TECHNICAL FIELD

This invention relates to fishing using artificial bait, and more particularly to a means to retain a paste-like fishing bait which is retained by the construction and shape of pliable beads which are designed to fit over the eye and/or the shank of the fish hook and retain the bait during the casting and trolling process.

### BACKGROUND OF THE INVENTION

it has long been a frustration of fisher folk in that for one reason or another the bait, whether natural or artificial, will be released, resulting in fishing with a bare hook, which is unproductive. Fisher folk have utilized various means throughout history for retaining the bait on the hook, including intricate baiting methods as well as mechanical means for retaining the bait.

The following prior art is known to the present inventor:

U.S. Pat. No. 2,513,548 to Buss discloses a coil spring which is mounted to the shaft of the hook to retain bait.

U.S. Pat. No. 3,399,483 to Naffzyger discloses a fishhook wherein the shaft is folded back on itself, forming a gap to provide resistance to the bait as well as a retaining spring element.

U.S. Pat. No. 3,863,383 to Lore discloses a bait saver which includes a pair of washers mounted to the shank of a fish hook and the leader is secured to the shank, retaining the bait between the two washers.

U.S. Pat. No. 4,827,657 to Slehofer discloses a device which includes a flat wire spiral on the shank of the hook to retain the bait.

U.S. Pat. No. 5,230,178 to Dillard discloses a threaded capsule attachment to a hook which is then inserted into the bait.

U.S. Pat. No.5,274,947 to Griffiths discloses a bait retainer which is wire helix movable along the shaft and inserted through the interior of the bait,

U.S. Pat. No. 5,333,407 to Merritt discloses a fishhook which includes a spiral element including a separate loop which is secured to the bait mounted on the hook.

U.S. Pat. No. 5,784,827 to Jimenez Jr, et al. discloses a singular filament formed into a diametrical serpentine configuration with a bend formed in the middle. The bend forms a self-enclosed open loop allowing the universal hook attachment and opposing open ends of the device allow it to be threaded into and be enclosed into the leading end of the bait.

U.S. Pat. No. 5,904,001 to Rabideau discloses a spindle bayonet fish hook apparatus wherein the spindle is inserted into one end of the bait and the hook is used to retain the opposite end of the bait.

U.S. Pat. No. 5,950,351 to Walker et al. discloses an elongated wire shank surrounded by a spiral form in fluorescent shades mounted above a triple hook.

U.S. Pat. No. 6,405,477 to Huppert discloses a molded plastic keeper added to the eye of a fishhook, the keeper having a plurality of rearwardly facing conical sections to be inserted into the bait.

U.S. Pat. No. 6,637,148 to Stallings discloses a fishhook having a barb at each end such that the bait is trapped between the curve of the hook and the upward barb.

U.S. Pat. No. 7,841,127 to Nakamichi discloses a fishhook with a spiral wire surrounding a portion of a straight wire pin connected to the eye and inserted into the one end of a bait and the barb of the hook then inserted in the other end of the bait.

U.S. Patent Application Publication No. 2003/0037479 to Wyatt discloses an expandable bait sleeve to be mounted to the shank and leader.

U.S. Patent Application Publication No. 2006/0213110 to Nhou et al. discloses a cage formed of dried and compressed plant matter wherein the cage forms an open end for passing the bait into the cage. A fishing hook is pressed through the cage and bait to hold those two elements securely while fishing.

### SUMMARY OF THE INVENTION

With the above-noted prior art in mind, it is possible to devise a superior method. of retaining paste-like artificial bait to the hook such that it is retained during casting and/or trolling. The present invention contemplates a synthetic bead-like structure which is to be threaded over the hook and shank of a fishing hook and having irregularities on the surface thereof and detents or bores within the surface, such that the fishing bait paste can be pressed into the bead and be held in position by friction with the bead.

It is to be understood that the fishing bead may come in many configurations and colors, such that it not only retains the bait for the fishing process but also acts as a further attractant to a fish.

It is a further purpose of the present invention to provide a means for retaining paste-like bait to the hook and to provide a device which is inexpensive to manufacture and is reusable.

### BRIEF DESCRIPTION OF THE DRAWINGS

FIG. 1 is an elevational view of one enlarged embodiment of the invention.

FIG. 1A is an end view of the bead of FIG. 1 without the hook.

FIG. 2 is a plan view of the embodiment of FIG. 1.

FIG. 3 is an isometric view of another enlarged embodiment of the invention.

FIG. 4 is an exploded view of the embodiment of FIG. 3 about to be placed over the eye of a hook.

FIG. 5 is an illustration of the embodiment of FIG. 3 in place over the eye and the shank of the hook.

### BEST MODE FOR CARRYING OUT THE INVENTION

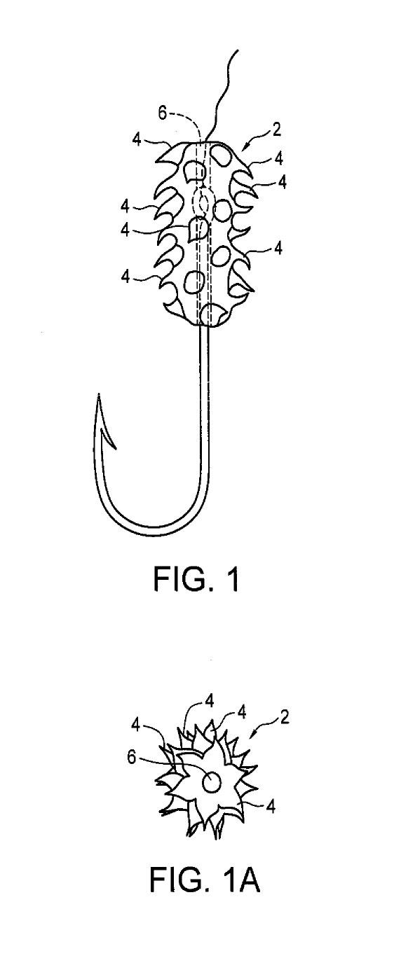

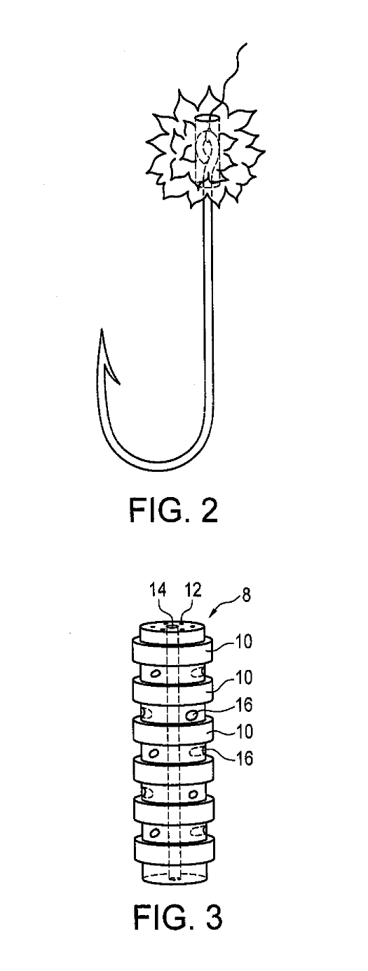

As seen in FIG. 1, the illustrative embodiment is non-definitive and not to scale other than the fact that it is constructed of a pliable material and is fabricated of a resilient material that is both durable, so that it resists being torn or permanently disfigured, as well as being resistant of the elements it is expected to endure, namely, fresh and salt water, sand, pebbles and the like. Further, as seen in FIGS. 1 and 2, the exterior of the bait bead includes a plurality of outwardly projecting flexible horns, such that the exterior surface creates a plurality of irregular indentations such that a paste-like fish bait can be worked into the exterior of the bait bead 2 and be frictionally secured in place to resist the rigors of being cast and/or trolled while still retaining the paste. It is to be understood that the fishing paste is readily available and includes both a distinctive color to attract the attention of the fish, as well as an odiferous element, To further enhance attraction of the bait, the bait bead itself is envisioned as being provided in a plurality of iridescent colors.

Further, in FIG. 1A, and end view of the bead of FIG. 1 is shown without the hook using the same descriptive numbers.

As further seen in FIGS. 1 and 2, the bait bead embodiment shown includes a bore 6 to receive the eye and shaft of the fishhook.

FIG. 3 shows another embodiment, wherein the bait bead includes a plurality of spaced axial disc configurations, Although it is embodied in a single element, it could be segmented. The bead 8 is unitary and includes in addition to the ridges 10 a plurality of axial bores 12 surrounding the a central bore 14 and a plurality of shallow bores 16 radially place around the bait bead. It is to be understood that the ridges, in addition to being coaxial, could also be spiral, and the bores 16 can be of any convenient depth. Again, the intent and purpose of the bait bead is that it be flexible, durable, be attractive to fish and designed to capture and hold the bait paste while being placed over the exterior of the eye and shank of the hook.

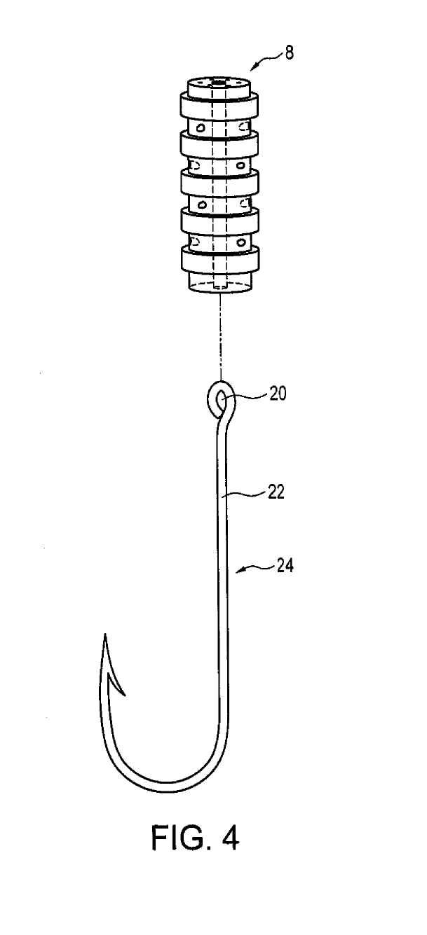

Referring to FIG. 4, the embodiment of FIG. 3 can be seen about to be placed over the eye 20 and shank 22 of the fishhook 24.

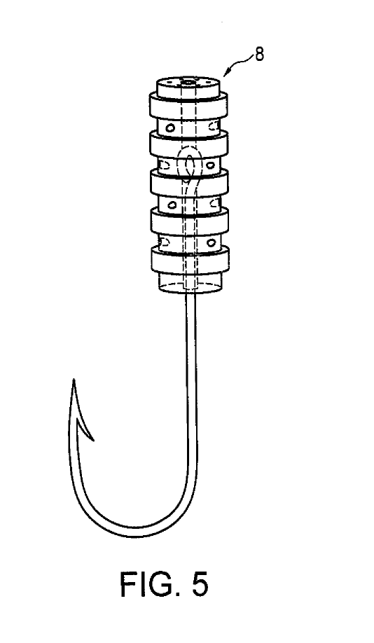

Reference is now had to FIG. 5, wherein the bait bead 8 can be seen in position over the eye and shaft of the hook to receive the bait paste.

It is to be understood that the embodiments shown are for illustrative purposes and not limiting of the invention.

Although a preferred embodiment of the invention has been disclosed for purposes of illustration, it should be understood that various changes, modifications and substitutions may he incorporated in the embodiment without departing from the spirit of the invention, which is defined by the claims which follow.

What is claimed is:

1. A fishing aid to be used in conjunction with a fishing hook comprising a small soft pliable member having an opening to snugly receive the eye of the hook and includes means on its exterior surface to retain bait in the form of paste.

2. A fishing aid as in claim 1, wherein the means to retain the bait includes additional openings in the fishing aid to capture the paste.

3. A fishing aid as in claim 1, wherein the means to ream the bait includes irregularities on the surface of the fishing aid to capture the paste.

4. A fishing aid to be used in conjunction with a fishing hook, comprising a small, soft, pliable, durable member to snugly receive the eye of the hook

5. A fishing aid as in claim 4, wherein the aid is of a distinctive color.

6. A fishing aid as in claim 4, wherein the exterior surface of the aid is configured to retain fishing paste.
